(19) United States
(12) Patent Application Publication
(10) Pub. No.: US 2005/0270397 A1
(43) Pub. Date: Dec. 8, 2005

(54) System and method for indicating settings

(76) Inventor: Amy E. Battles, Windsor, CO (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 10/859,029

(22) Filed: Jun. 2, 2004

(51) Int. Cl. H04N 5/222

(52) U.S. Cl. 348/333.01

(57) ABSTRACT

A system and method for indicating settings of an image capture device. One embodiment comprises receiving light information from a photosensor; generating a histogram and at least one setting value based upon the received light information; and displaying the histogram and the setting value on a display residing on the image capture device.

### BACKGROUND

Images may be difficult to capture since the amount of exposure compensation and/or contrast compensation must be controlled to capture an image having desirable exposure and/or contrast qualities. For example, photographing objects of interest at night requires a relatively greater exposure setting than images captured under bright natural ambient lighting conditions. In other situations, capturing images of highly detailed objects may require a relatively higher contrast setting during image capture.

Histograms provide visual information to a viewer regarding the relative exposure and contrast of an image (and/or the background of the image). Such histograms may be displayed on an image capture device's display. However, to adjust image capture parameters, the user of the image capture device must end the display of the histogram and make desired changes to the image capture parameter settings via a displayed menu. Accordingly, the user does not have the benefit of immediately understanding the effect of the changes made to the image capture parameters, such as exposure or contrast settings.

### SUMMARY

One embodiment of the invention comprises receiving light information from a photosensor; generating a histogram and at least one setting value based upon the received light information; and displaying the histogram and the setting value on a display residing on the image capture device.

Another embodiment comprises a photosensor configured to detect light from an object; a processor configured to determine a setting of an image capture parameter, determine a histogram from the information received from the photosensor and determine at least one setting value; and a display configured to display the preview image and the setting value received from the processor.

### BRIEF DESCRIPTION OF THE DRAWINGS

The components in the drawings are not necessarily to scale relative to each other. Like reference numerals designate corresponding parts throughout the several views.

FIG. 1 is an illustrative image prepared by an embodiment of the user assistance system displayed on a display device.

FIGS. 2A-C are diagrams of exemplary views illustrating exposure and contrast information shown by the histogram displayed concurrently with setting values prepared by an embodiment of the user assistance system.

FIGS. 3A-C are diagrams of exemplary views illustrating exposure and contrast information shown by the histogram displayed concurrently with setting values prepared by another embodiment of the user assistance system.

FIG. 4 shows a flow chart illustrating an embodiment of a histogram display and exposure/contrast control system in an image capture device.

FIG. 5 shows a flow chart of an embodiment of a method of indicating settings of an image capture device.

### DETAILED DESCRIPTION

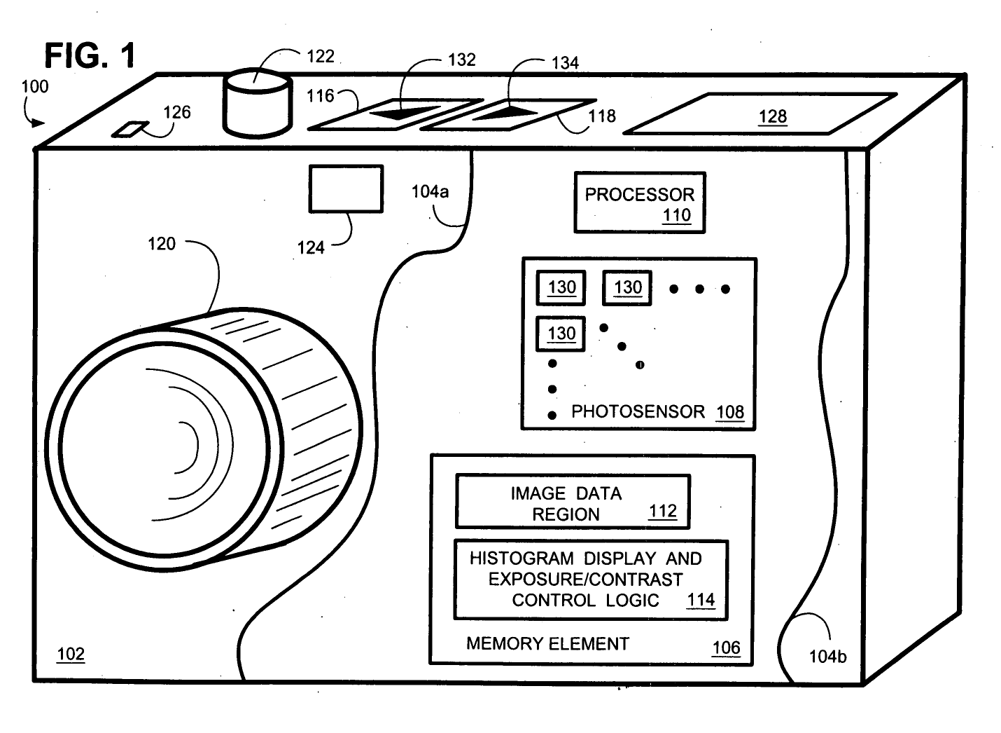

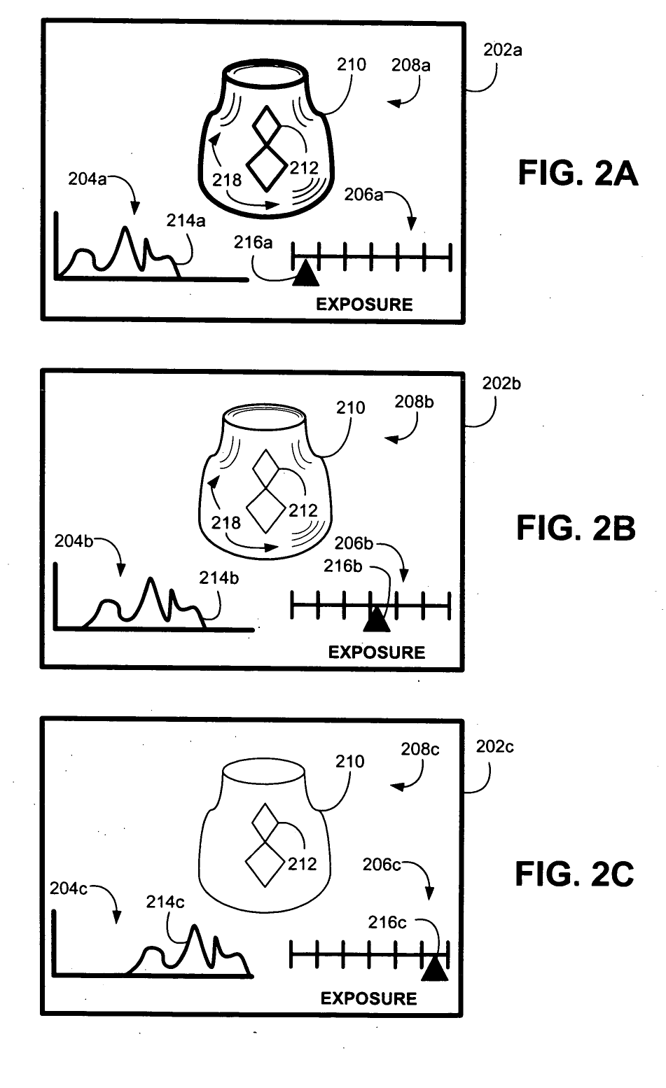

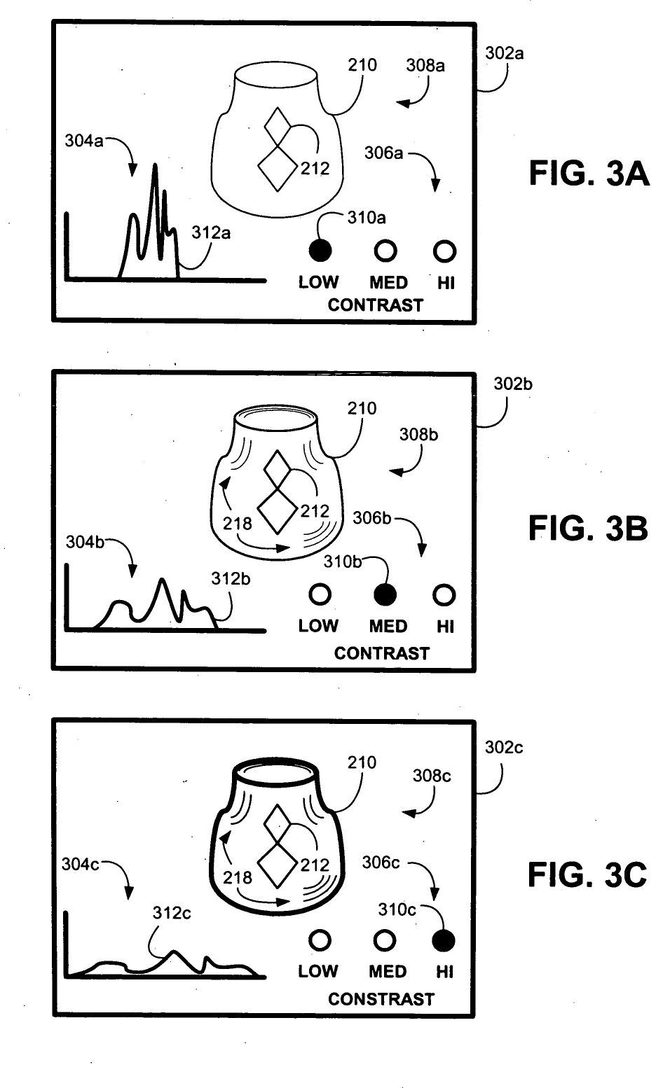

FIG. 1 is a block diagram illustrating an embodiment of a histogram display and exposure/contrast control system 100 implemented in an image capture device 102. The histogram display and exposure/contrast control system 100 provides a system and method for displaying a histogram 204a-c and corresponding setting values 210a-c (FIGS. 2A-2C, respectively). In one embodiment, as exposure and/or contrast settings are modified by the user via controllers 116 and 118 (or other suitable controllers), an adjusted histogram 204a-c and setting values 210a-c are concurrently displayed on display 128 (in response to the exposure and/or contrast changes). Accordingly, the user is able to view the changes to the histograms 208a-c and the setting values 210a-c resulting from the above-described changes made to the exposure and/or contrast. In another embodiment, changes in exposure and/or contrast are made via a suitable menu. In yet another embodiment, a preview image is also displayed, with the histograms 204a-c and setting values 206a-c (or histograms 304a-c and setting values 306a-c of FIG. 3) displayed over, superimposed on, or overlaid on top of the preview image. Accordingly, the user is able to view the changes to the preview image resulting from the above-described changes made to the exposure and/or contrast.

FIG. 1 includes selected external and internal components of the image capture device 102, demarked by cut-away lines 104a and 104b. Internal components, illustrated between cut-away lines 104a and 104b, include at least memory element 106, photosensor 108 and processor 110. In one embodiment, memory element 106 includes an image data region 112 for storing captured images and the histogram display and exposure/contrast control logic 114. In another embodiment, the image data region 112 resides in a suitable detachable memory device (not shown).

Image capture device 102 includes as external components optional controllers 116 and 118, a lens unit 120, an image capture actuation button 122, an optional viewfinder 124, a power switch 126 and a display 128. The display 128 displays the histogram 204a-c and setting values 206a-c (FIGS. 2A-C, respectively) for viewing by the user before image capture. Display 128 is any suitable device used for viewing preview images, histograms, setting values, menu, and/or captured images. For convenience of illustration, display 128 is illustrated on the top of image capture device 102.

Operation of the image capture device 102 is initiated by actuation of the power switch 126 or an equivalent device having the same functionality. Display 128 may display an image of an object currently visible through the viewfinder 124 and/or detected by photosensor 108, referred to herein as a preview image. Accordingly, the preview image is a “live view” of the object before image capture.

Photosensor 108 comprises a matrix of light detecting photosensitive sites 130. As each of the photosensitive sites 130 are exposed to light passing through the lens unit 120, the photosensitive sites 130 collect charge or the like in proportion to the amount of light detected during the image capture exposure period. Accordingly, at the conclusion of image capture exposure period, or when light information corresponding to the preview image is generated, light information from the photosensitive sites 130 can be determined such that the determined light information corresponds to the amount of light detected by each photosensitive site 130. This process of obtaining light information from photosensitive sites 130 is referred to hereinafter as “reading” the photosensitive sites 130. Photosensitive sites 130 may also be referred to herein as “pixels” for convenience.

As noted above, prior to capturing an image, the user of the image capture device 102 may view a preview image on display 128 or view the object to be captured through viewfinder 124. Photosensor 108 is disposed in a suitable location behind lens unit 120 such that an image of object to be captured may be focused onto photosensor 108 for capturing. When the user has focused the image and is satisfied with the focused image, the user actuates the image capture actuation button 122 (also referred to as a shutter button or a shutter release button) to cause image capture device 102 to capture an image of the object.

FIGS. 2A-C are diagrams of exemplary views 202a, 202b and 202c, respectively, illustrating exposure and contrast information shown by histograms 204a-c, respectively, displayed concurrently with setting values 206a-c, respectively, prepared by an embodiment of the user histogram display and exposure/contrast control system 100. Also included in this exemplary embodiment is an optional display of preview images 208a-c, respectively, of ajar 210 with a design 212 thereon.

A histogram is generated by plotting how many times a particular exposure level (or range) occurs for the photosensitive sites 130 (FIG. 1) that are periodically read for generating the preview image. Different exposure values (or ranges) are plotted along the horizontal axis in increasing order. An exposure value corresponds to a value of the light information received from each non-destructive reading of the photosensor sites 130. Position of individual points on the histogram (for plotted exposure values or ranges) are determined by summing the corresponding occurrences of a particular value (or range) of exposure values from the photosensitive sites 130.

Histograms provide visual information to a viewer regarding the relative exposure and contrast of the preview image. The location of a graph, plot or the like along the horizontal axis of a histogram indicates relative exposure of the preview image. In an under-exposed situation, many pixels are not detecting a relatively large amount of light such that light information from those pixels will be difficult to distinguish from the color black. Accordingly, the graph 214a would be shifted to the left side of the horizontal axis of histogram 204a, as illustrated in FIG. 2A. Conversely, in an over-exposed situation, many pixels are detecting a relatively large amount of light such that light information from those pixels will be difficult to distinguish from the color white. Accordingly, histogram graph 214c would be shifted to the right side of the horizontal axis of histogram 204c, as illustrated in FIG. 2C.

In low contrast situation, many of the pixels are detecting a relatively similar amount of light such that light information from those pixels will be difficult to distinguish from each other. Accordingly, a histogram graph 312a would be relatively narrow with relatively high peaks along the horizontal axis of histogram 304a, as illustrated in FIG. 3A. Conversely, in a high contrast situation, many pixels are detecting a relatively different amount of light such that light information from those pixels will be easily distinguished from each other. Accordingly, a histogram graph 312c would be relatively broader with relatively lower peaks along the horizontal axis of histogram 304c, as illustrated in FIG. 3C.

Setting values are concurrently displayed with histograms so that the user can understand the current image capture parameter setting(s) that will be used during image capture. In FIGS. 2A-2C, the setting values 206a-c, respectively, are illustrated for convenience as a horizontal scale with an indicia 216a-c, respectively, to indicate the current setting value corresponding to the value of the image capture parameter. Additional indicia, such as numbers and/or letters (not shown) may be optionally included as part of the setting values 206a-c.

FIGS. 2A-2C illustrate the effect that a user may have on preview images 208a-c, respectively, when the exposure setting is adjusted by the user based upon information provided by the histograms 204a-c, respectively, and/or setting values 206a-c, respectively. FIG. 2A is a view 202a of a histogram 204a, setting value 206a and an optional preview image 208a displayed on display 128 (FIG. 1) wherein the image capture setting of interest corresponds to image exposure. A user viewing the view 202a understands that based upon the current settings, corresponding to “exposure” in this simplified example, the photosensitive sites 130 (FIG. 1) will capture an image with relatively little exposure. Graph 214a indicates that the photosensitive sites 130 will detect a relatively small amount of light since the graph 214a is closer to the left-hand side of the horizontal axis of histogram 204a.

Furthermore, the indicia 216a located on the right-hand side of the horizontal axis on setting value 206a similarly indicates that the current exposure setting will result in an under-exposed or lightly exposed image when captured. In some embodiments, supplemental alpha-numeric information may be included with the setting value 206a, thereby making the information for the user more meaningful. For example, the phrase “Exposure” is displayed on the views 202a-c to indicate that the setting values 206a-c, respectively, correspond to the current exposure setting of the image capture device 102 (FIG. 1). Such descriptive text may be displayed in any convenient location, and is shown below the setting values 206a-c for convenience of illustration.

This under-exposure or light exposure situation is also indicated by the nature of the above-described preview image 202a, wherein the details 218 on jar 210 are discernable as dark lines. In the simplified illustrative example of FIGS. 2A-2C, it is assumed that the user actuates a suitable controller to increase exposure. FIG. 2B is a view 202b displaying another histogram 204b, setting value 206b and another optional preview image 208b displayed on display 128 (FIG. 1), based upon an adjustment made to the exposure setting.

In FIG. 2B, graph 214b indicates that the photosensitive sites 130 (FIG. 1) will detect relatively more light during image capture since the graph 214b is closer to the center of the horizontal axis of histogram 204b. Indicia 216b, located near the center of the horizontal axis on setting value 206b, similarly indicates that the current exposure setting will result in a more exposed image when captured. Preview image 202b shows that the jar 210 is still discernable, although relatively lighter (as compared to the preview image 208a of FIG. 2A). Details 218 of the jar 210 are less visible (as compared to the preview image 208a of FIG. 2A). Accordingly, the user viewing the view 202b understands that with the exposure setting change made (that corresponds to the histogram 204b and setting value 206b of FIG. 2B), image capture device 102 will capture an image with relatively more exposure than an image captured with the above-described exposure settings of FIG. 2A.

In the simplified illustrative example of FIGS. 2A-2C, it is next assumed that the user actuates a suitable controller to again increase the exposure setting. FIG. 2C is a view 202c displaying another histogram 204c, setting value 206c and another optional preview image 208c displayed on display 128 (FIG. 1), based upon an adjustment made to the exposure setting.

In FIG. 2C, graph 214c indicates that the photosensitive sites 130 (FIG. 1) will detect relatively more light during image capture since the graph 214c is closer to the right-hand side of the horizontal axis of histogram 204c. Indicia 216c, located near the right side of the horizontal axis on setting value 206c, similarly indicates that the current exposure setting will result in a more exposed image when captured. Preview image 208c shows that the jar 210 is barely discernable. Accordingly, the user viewing the view 202c understands that with the exposure setting change made (that corresponds to the histogram 204c and setting value 206c of FIG. 2C), image capture device 102 will capture an image with relatively more exposure than images captured with the above-described exposure settings of FIG. 2A or 2B.

Setting values may also correspond to different image capture parameters, such as contrast. FIGS. 3A-C are views 302a-c, respectively, of histogram 304a-c, setting values 306a-c, and preview images 308a-c, respectively displayed on display 128 (FIG. 1) wherein the image capture setting of interest corresponds to image contrast. In FIGS. 3A-3C, the setting values 306a-c, respectively, are illustrated for convenience as a plurality of circles, with an indicia 310a-c illustrated as a dark dot or “filled in” circle. Indicia 310a-c indicate the current contrast setting of the image capture device 102. In some embodiments, alpha-numeric text may be optionally included as part of the setting values 306a-c. Here, the text “LOW” indicates a low contrast setting, “MED” indicates a medium contrast setting, and “HI” indicates a high contrast setting.

FIG. 3A is a view 302a of a histogram 304a, setting value 306a and an optional preview image 308a displayed on display 128 (FIG. 1) wherein the image capture setting of interest corresponds to image contrast. A user viewing the view 302a understands that based upon the current contrast setting of this simplified example, the photosensitive sites 130 (FIG. 1) will capture an image with relatively little contrast. Graph 312a indicates that the photosensitive sites 130 will provide an image with relatively low contrast since the graph 312a is relatively narrow with high peaks.

Furthermore, the indicia 310a located on the circle labeled “LOW” similarly indicates that the current contrast setting will result in a captured image with relatively low contrast. In some embodiments, supplemental alpha-numeric information may be included with the setting value, thereby making the information for the user more meaningful. For example, the phrase “CONTRAST” is displayed on the views 302a-c indicate that the setting values 306a-c, respectively, correspond to the current contrast setting of the image capture device 102 (FIG. 1). Such descriptive text may be displayed in any convenient location, and is illustrated below the setting values 306a-c for convenience of illustration.

This low contrast situation is also indicated by the nature of the above-described preview image 308a, wherein the details of the jar 210 are barely discernable from each other. In the simplified illustrative example of FIGS. 3A-3C, it is assumed that the user actuates a suitable controller to adjust contrast. FIG. 3B is a view 302b displaying another histogram 304b, setting value 306b and another optional preview image 308b displayed on display 128 (FIG. 1), based upon an adjustment made to the contrast.

In FIG. 3B, graph 312b indicates that the photosensitive sites 130 (FIG. 1) will provide more contrast during image capture since the graph 312b is now wider. Indicia 310b, located on the circle labeled “MED”, similarly indicates that the current contrast setting will result in a medium contrast image when captured. Preview image 308b shows that the jar 210 is more discernable. Details 218 of the jar 210 are more discernable (as compared to the preview image 308a of FIG. 3A). Accordingly, the user viewing the view 302b understands that with the contrast setting change made (that corresponds to the histogram 304b and setting value 306b of FIG. 3B), image capture device 102 will capture an image with relatively more contrast than an image captured with the above-described contrast setting of FIG. 3A.

In the simplified illustrative example of FIGS. 3A-3C, it is next assumed that the user actuates a suitable controller to again adjust the contrast setting. FIG. 3C is a view 302c displaying another histogram 304c, setting value 306c and another optional preview image 308c displayed on display 128 (FIG. 1), based upon an adjustment made to the contrast.

In FIG. 3C, graph 312c indicates that the photosensitive sites 130 (FIG. 1) will provide more contrast during image capture since the graph 312c is now even more broader with lower peaks than shown in FIG. 3B. Indicia 310c, located on the circle labeled “HI”, similarly indicates that the current contrast setting will result in a greater contrast image when captured. View 302c shows that the jar 210, design 212 and details 218 are even more discernable since the preview image 308c is generated with greater contrast. Details 218 of the jar 210 are now clearly visible (as compared to the preview image 308b of FIG. 3B). Accordingly, the user viewing the view 302c understands that with the contrast setting change made (that corresponds to the histogram 304c and setting value 306c of FIG. 3C), image capture device 102 will capture an image with relatively high contrast as compared to images captured with the above-described contrast settings of FIG. 3A or 3B.

For convenience of illustration, the setting values for exposure in FIGS. 2A-2C were illustrated as a scale. In another embodiment, a plurality of indicia in FIGS. 2A-2C could be used to indicate exposure settings that appear similar to the setting values of FIGS. 3A-3C. For example, if the image capture device 102 provided for three exposure settings, they could have been indicated using three circles labeled with text such as “LOW” to indicate a low exposure setting, “MED” to indicate a medium exposure setting, and “HI” to indicate a high exposure setting (or any other suitable alpha-numeric text, such as “1”, “2” and “3”, or, “A”, “B”, and “C”). Here, the indicia would be illustrated as a dark dot or “filled in” circle, thereby indicating the current setting of the image exposure. It is understood that any suitable number of setting indicia could be used by other embodiments.

Furthermore, the setting values for contrast in FIGS. 3A-3C could be illustrated using a scale similar to that of FIGS. 2A-2C. The indicia 308a-c would indicate the current contrast setting relative to position on the scale.

Other types of setting values may be used by alternative embodiments of the histogram display and exposure/contrast control system 100. Non-limiting examples of such indicia include bar or pie charts, clock-like indicia, or other graphical indicia. Such indicia could correspond to exposure and/or contrast.

In one embodiment, the photosensitive sites 130 that are read to obtain light information to determine exposure and contrast (and accordingly determine the histogram and the setting value) are the same photosensitive sites 130 that are read to obtain the preview image. In another embodiment, all of the photosensitive sites 130 are read to obtain light information to determine exposure and contrast (and accordingly determine the histogram and the setting value). In another embodiment, selected ones of the photosensitive sites 130 are read to obtain light information to determine exposure and contrast (and accordingly determine the histogram and the setting value).

As described herein, a user of the image capture device 102 (FIG. 1) adjusts exposure and/or contrast based upon viewing a histogram, setting value and preview image determined based upon the current exposure and/or contrast settings. Embodiments of the histogram display and exposure/contrast control system 100 (FIG. 1) may be configured to receive exposure and/or contrast setting changes from any suitable controller or setting adjustment means. For example, controllers 116 and 118 provide a simplified exemplary illustration of two possible controllers that are configured to adjust exposure and/or contrast. Illustrated on the controllers 116 and 118 are arrows 132 and 134, respectively, in opposing directions. Other controllers may be used to confirm a setting selection by the user, such as, but not limited to, controllers corresponding to “selection OK,” “exposure OK,” or “selection confirm.” The above-described controllers 116 and 118 may be any suitable actuating device configured to at least allow a user to cause encryption of an image file according to the present invention. Examples of controllers 116 and 118 include, but are not limited to, a push-button, a toggle-switch, a multi-position sensing device configured to sense a plurality of switch positions, a touch sensitive device or a light sensitive device.

In the illustrated embodiment, when the user actuates controller 116, the displayed adjustment to the setting value would correspond to the relative direction shown by arrow 132. For example, if the user desired to increase exposure, actuation of controller 116 could be configured to increase the exposure setting of the image capture device, and also adjust the position of the indicia 216a-c (FIGS. 2A-2C) to the right (to indicate an increase in exposure). Thus, a signal is generated by the actuated controllers 116 and/or 118 and is communicated to processor 110 (FIG. 1) to increase exposure.

Similarly, if the user desired to decrease exposure, actuation of controller 118 could be configured to decrease the exposure setting of the image capture device, and also adjust the position of the indicia 216a-c to the left (to indicate a decrease in exposure). Changes in the display of the indicia 216a-c location and the preview image 208a-c, respectively, would be made concurrently with the actuation of the controllers 116 and/or 118. Thus, a signal is generated by the actuated controllers 116 and/or 118 and is communicated to processor 110 to decrease exposure.

Similarly, adjustments could be made to contrast by actuation of controllers 116 and/or 118. For example, if the user desired to increase contrast, actuation of controller 116 could be configured to increase the contrast setting of the image capture device, and also adjust the position of the indicia 310a-c (FIGS. 3A-3C) to the right (to indicate an increase in contrast). Thus, a signal is generated by the actuated controllers 116 and/or 118 and is communicated to processor 110 to increase contrast.

Similarly, if the user desired to decrease contrast, actuation of controller 118 could be configured to decrease the contrast setting of the image capture device, and also adjust the position of the indicia 310a-c to the left (to indicate a decrease in contrast). Changes in the display of the indicia 310a-c location and the preview image 308a-c, respectively, would be made concurrently with the actuation of the controllers 116 and/or 118. Thus, a signal is generated by the actuated controllers 116 and/or 118 and is communicated to processor 110 to decrease contrast.

In other embodiments, adjustment to exposure and/or contrast may be effected using a multi-function controller, or with different sets of dedicated controllers. Or, adjustment to exposure and/or contrast may be effected using a menu system. Thus, information is generated via the menu and is communicated to processor 110 to increase/decrease exposure and/or contrast.

The embodiments above were described as displaying a histogram and preview image, along with either a setting value corresponding to image exposure (206a-c in FIGS. 2A-2C), or a setting value corresponding to image contrast (306a-c in FIGS. 3A-3C). In another embodiment, a histogram, a setting value corresponding to exposure (206a-c in FIGS. 2A-2C), a setting value corresponding to contrast (306a-c in FIGS. 3A-3C), and a preview image are displayed. In another embodiment, the preview image is optional or is not shown.

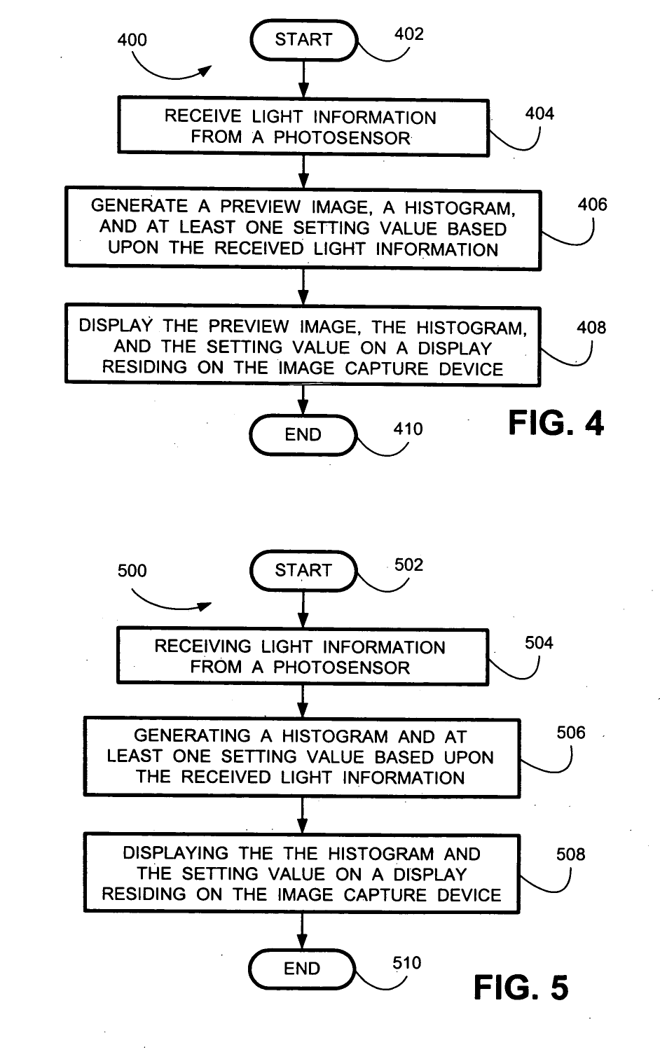

FIG. 4 shows a flow chart 400 illustrating an embodiment of a histogram display and exposure/contrast control system 100 in an image capture device 102 (FIG. 1). The flow chart 400 of FIG. 4 shows the architecture, functionality, and operation of an embodiment for implementing the histogram display and exposure/contrast control logic 114 (FIG. 1) such that a histogram and preview image, along with either a setting value corresponding to exposure (206a-c in FIGS. 2A-2C), or a setting value corresponding to contrast (306a-c in FIGS. 3A-3C), are displayed, as described above in accordance with the present invention. An alternative embodiment implements the logic of flow chart 400 with hardware configured as a state machine. In this regard, each block may represent a module, segment or portion of code, which comprises one or more executable instructions for implementing the specified logical function(s). It should also be noted that in some alternative implementations, the functions noted in the blocks may occur out of the order noted in FIG. 4, or may include additional functions. For example, two blocks shown in succession in FIG. 4 may in fact be substantially executed concurrently, the blocks may sometimes be executed in the reverse order, or some of the blocks may not be executed in all instances, depending upon the functionality involved, as will be further clarified hereinbelow. All such modifications and variations are intended to be included herein.

The process begins at block 402. At block 404, light information from a photosensor is received. At block 406, a preview image, a histogram and at least one setting value based upon the received light information are generated. At block 408, the preview image, the histogram and the setting value are displayed on a display residing on the image capture device. The process ends at block 410.

FIG. 5 shows a flow chart 500 of an embodiment of a method of indicating settings of an image capture device. An alternative embodiment implements the logic of flow chart 500 with hardware configured as a state machine. In this regard, each block may represent a module, segment or portion of code, which comprises one or more executable instructions for implementing the specified logical function(s). It should also be noted that in some alternative implementations, the functions noted in the blocks may occur out of the order noted in FIG. 5, or may include additional functions. For example, two blocks shown in succession in FIG. 5 may in fact be substantially executed concurrently, the blocks may sometimes be executed in the reverse order, or some of the blocks may not be executed in all instances, depending upon the functionality involved, as will be further clarified hereinbelow. All such modifications and variations are intended to be included herein.

The process begins at block 502. At block 504, light information from a photosensor is received. At block 506, a histogram and at least one setting value based upon the received light information are generated. At block 508, the histogram and the setting value are displayed on a display residing on the image capture device. The process ends at block 510.

In some instances, the left edge of a histogram and/or the right edge of a histogram may show a straight vertical line (as compared to the decreasing tails of the histograms illustrated in FIGS. 2A-C and 3A-C) at an end of the horizontal axis. A vertical line at the far left end of the horizontal axis of a histogram indicates to the user that pixels are being clipped due to underexposure. That is, some pixels, when exposed at a relatively higher exposure would show darker shades of gray, are showing black because of the lower exposure. A vertical line at the far right end of the horizontal axis of a histogram indicates to the user that pixels are being clipped due to overexposure. That is, some pixels, when exposed at a relatively lower exposure would show light shades of gray, are showing white because of the higher exposure. Such clipping causes less detail in the captured image, and therefore may be undesirable. Embodiments of the histogram display and exposure/contrast control system 100 allow the user to perceive such clipping and adjust exposure and/or contrast settings to compensate the clipping caused by current exposure and/or contrast settings.

Embodiments of the invention implemented in memory element 106 (FIG. 1) may be implemented using any suitable computer-readable medium. In the context of this specification, a “computer-readable medium” can be any means that can store, communicate, propagate, or transport the data associated with, used by or in connection with the instruction execution system, apparatus, and/or device. The computer-readable medium can be, for example, but not limited to, an electronic, magnetic, optical, electromagnetic, infrared, or semiconductor system, apparatus, device, or propagation medium now known or later developed.

It should be emphasized that the above-described embodiments are merely examples of implementations. Many variations and modifications may be made to the above-described embodiments. All such modifications and variations are intended to be included herein within the scope of this disclosure and protected by the following claims.

1. A system which indicates settings of an image capture device, comprising:
a photosensor configured to detect light from an object;
a processor configured to determine a setting of an image capture parameter, determine a histogram from information received from the photosensor and determine at least one setting value; and
a display configured to display the histogram and the setting value received from the processor.

2. The system of claim 1, wherein the processor determines a preview image from the information received from the photosensor and wherein the display displays the preview image.

3. The system of claim 1, wherein the image capture parameter corresponds to exposure.

4. The system of claim 1, wherein the image capture parameter corresponds to contrast.

5. The system of claim 1, further comprising at least one controller configured to adjust the image capture parameter such that the histogram and the setting value are adjusted to correspond to the adjusted image capture parameter, and such that the adjusted histogram and the adjusted setting value are displayed on the display.

6. The system of claim 5, further comprising:
a memory element; and
a histogram and exposure/contrast control logic, wherein the logic is configured to determine an adjusted histogram and the adjusted setting value based upon an adjustment made to the image capture parameter.

7. A method for indicating settings of an image capture device, the method comprising the steps of:
receiving light information from a photosensor;
generating a histogram and at least one setting value based upon the received light information; and
displaying the histogram and the setting value on a display residing on the image capture device.

8. The method of claim 7, further comprising:
generating a preview image; and
displaying the preview image.

9. The method of claim 7, wherein the setting value corresponds to exposure.

10. The method of claim 7, wherein the setting value corresponds to contrast.

11. The method of claim 7, further comprising the steps of:
generating a first setting value corresponding to exposure based upon the detected light information;
generating a second setting value corresponding to contrast based upon the detected light information; and
displaying the first setting value and the second setting value.

12. The method of claim 7, further comprising the step of displaying an indicia on the setting value, the indicia corresponding to a current value of an image capture parameter associated with the setting value.

13. The method of claim 7, further comprising the steps of:
receiving an adjustment to the setting value;
generating a second histogram and a second setting value based upon the adjusted setting value; and
displaying the second histogram and the second setting value on the display.

14. The method of claim 13, further comprising the steps of:
determining a value of an image capture parameter associated with the adjusted setting value; and
displaying an indicia on the adjusted setting value, the indicia corresponding to the value of the image capture parameter associated with the adjusted setting value.

15. The method of claim 13, further comprising the step of receiving a signal from at least one controller such that the setting value is adjusted.

16. The method of claim 13, further comprising the step of receiving an instruction from a menu such that the setting value is adjusted.

17. A system for indicating settings of an image capture device, comprising:
means for detecting light;
means for receiving light information corresponding to the detected light;
means for generating a histogram and at least one setting value based upon the detected light information; and
means for displaying the histogram and the setting value.

18. The system of claim 17, wherein the setting value corresponds to exposure.

19. The system of claim 17, wherein the setting value corresponds to contrast.

20. The system of claim 17, further comprising:
means for adjusting the setting value;
means for determining a value of an image capture parameter associated with the adjusted setting value;
means for displaying an indicia on the adjusted setting value, the indicia corresponding to the value of the image capture parameter associated with the adjusted setting value.

21. A computer-readable medium, comprising logic configured to perform the steps of:
generating a histogram and at least one setting value based upon light information received from a photosensor; and
communicating the histogram and the setting value to a display residing on an image capture device.

22. The computer-readable medium of claim 21, wherein the setting value corresponds to exposure.

23. The computer-readable medium of claim 21, wherein the setting value corresponds to contrast.

24. The computer-readable medium of claim 21, further logic configured to perform the steps of:
receiving information corresponding to an adjustment of the setting value;
generating a second histogram and a second setting value based upon the adjusted setting value; and
communicating the second histogram and the second setting value to the display.
